(19) United States
(12) Patent Application Publication
(10) Pub. No.: US 2012/0310846 A1
(43) Pub. Date: Dec. 6, 2012

(54) SYSTEM TO IDENTIFY MULTIPLE COPYRIGHT INFRINGEMENTS AND COLLECTING ROYALTIES

(76) Inventor: Robert Steele, Santa Monica, CA (US)

(21) Appl. No.: 13/485,178

(22) Filed: May 31, 2012

Related U.S. Application Data
(60) Provisional application No. 61/491,415, filed on May 31, 2011.

(51) Int. Cl. G06Q 10/00

(52) U.S. Cl. 705/309

(57) ABSTRACT

A system, a method and a computer program for determining multiple copyright infringement events, identifying a particular IP address—port number combination associated with the multiple infringement events, and notifying an ISP and/or a customer regarding the multiple copyright infringement events.

### CROSS REFERENCE TO PRIOR APPLICATIONS

This application claims priority to and the benefit thereof from U.S. Provisional Patent Application No. 61/491,415, filed on May 31, 2011, titled “System to Identify Multiple Copyright Infringements,” the entirety of which is incorporated herein by reference.

### FIELD OF THE DISCLOSURE

The present disclosure relates to a system, a method, and a computer program for identifying acts of copyright infringement. Specifically, the present disclosure is directed to a system, a method, and a computer program that provides a novel approach to presenting settlement offers to a user associated with one or more acts of copyright infringement.

### BACKGROUND OF THE DISCLOSURE

Digital piracy of copyright material is a substantial, worldwide problem for the music industry. For example, according to the International Federation of the Phonographic Industry (IFPI) Digital Music Report 2011, digital piracy has substantially contributed to the erosion of music industry revenues. The IFPI reports that global recorded music revenues declined by 31% from 2004-2010 as a result of such piracy. The IFPI has found that while some peer-to-peer sharing networks such as Limewire are in decline, the use of other peer-to-peer sharing networks such as BitTorrent are on the rise. Similarly, the Nielsen Company reports that nearly one in four active Internet users in Europe visit unlicensed content sites monthly. Although copyright infringement appears to be widespread, most acts of copyright infringement are carried out by a small number of individuals, in order to combat this problem, governments from around the world are beginning to shift some of the burden to Internet service providers (hereinafter “ISP”) to address acts of piracy occurring on their networks.

Established in 1997, the Digital Millenium Copyright Act (DMCA), which is also known as the “No Electronic Theft” Act, heightened the penalties for copyright infringement on the Internet and established the liability of the providers of on-line services of copyright infringement by their users. The Act outlawed the manufacture, sale, or distribution of code-cracking devices used to illegally copy software. The Act states that service providers may not allow the illegal downloading of copyright materials by means of their systems.

In trying to combat peer-to-peer copyright infringement, the music industry, for example, has spent millions of dollars searching for a technology breakthrough to protect copyrighted works. These technologies often include Digital Rights Management (DRM). DRM technologies attempt to prevent digital music player technology from allowing reproduction of the copyrighted works. However, DRM technologies generally suffer from the problem that if a reasonably talented technology person can listen to a music file, then that person can likely find a way to make a copy that does not have the DRM technology. Similarly, problems also exist with multimedia content copy prevention methods that are currently available.

The disclosure provides a novel method, system, and computer program to facilitate the recapture of lost revenue, which results from copyright infringement. In particular, the novel system, method, and computer program facilitate identification of acts of copyright infringement, documentation of the details surrounding the acts of copyright infringement, providing notice of the copyright infringement to ISPs, and presentation of a novel approach to settle and resolve obligations incurred as a result of an identified act of copyright infringement.

### SUMMARY OF THE DISCLOSURE

Accordingly, the present disclosure provides a system, a method, and a computer program that may mine a data stream of infringement data over a period of time, process the mined data to find correlations in the data, and identify specific sets of IP addresses and ports associated with acts of copyright infringement. The system, method, and computer program may be further configured to provide a settlement offer that may be accepted to resolve obligations incurred as a result of an identified act of copyright infringement.

Another aspect of the present disclosure provides a system for resolving an act of copyright infringement, comprising: an infringement module configured to identify an infringing computer, wherein the infringing computer includes a computer associated with an act of copyright infringement (an infringement event); an identification module configured to identify an ISP associated with the infringing computer; a notification module configured to notify the ISP that the infringing computer is associated with the infringement event; a receiving module configured to receive a redirected request for access to Internet content, wherein the request for Internet content has been redirected by the ISP; and a generation module configured to generate a redirect webpage, wherein the redirect webpage includes a link associated with a settlement webpage that includes a settlement offer to resolve the infringement event.

The redirect webpage may include information identifying the infringing computer.

The information identifying the infringing computer may include an IP address, a port number, and a timestamp.

The redirect webpage may include a notice of a settlement offer to resolve the infringement event.

The redirect webpage may include information identifying the copyrighted work in the infringement event.

The system may also include a link selection module configured to receive a selection of the link; and, a settlement resolution module configured to accept a predetermined payment from the user associated with the infringing computer in order to resolve the infringement event.

The predetermined payment may include a flat fee established for each infringement event associated with the infringing computer.

The system may also include a notification module configured to provide an ISP with a settlement confirmation notice, wherein the settlement confirmation notice indicates that all outstanding infringement events associated with the infringing computer have been resolved.

Another aspect of the disclosure provides a method for resolving an act of copyright infringement, comprising: receiving a redirected request for access to Internet content; and, providing a redirect webpage in response to the received redirected request for access to Internet content, wherein the redirect webpage includes a settlement offer to resolve an act of copyright infringement (an infringement event).

The received redirected request for access to Internet content may be redirected by an ISP.

The method may also include identifying an infringing computer, wherein the infringing computer includes a computer associated with the infringement event; identifying an ISP associated with the infringing computer; and, notifying the ISP that the infringing computer is associated with the infringement event.

The method may also include generating a redirect webpage, based at least in part, on a determination that a computer is associated with the infringement event.

The method may also include associating a link with the redirect webpage, wherein the link is associated with a settlement webpage that a user can access to accept the settlement offer to resolve the infringement event.

The method may also include determining if all outstanding infringement events associated with the infringing computer have been resolved.

The method may also include providing an ISP with a settlement confirmation notice, wherein the settlement confirmation notice indicates that all outstanding infringement events have been resolved for the infringing computer.

Another aspect of the present disclosure provides a computer readable medium including instructions, which when executed by a computer, causes the computer to perform a method for resolving an act of copyright infringement, the instructions comprising: instructions for receiving a redirected request for access to Internet content, wherein the request for Internet content has been redirected by an ISP; instructions for generating a redirect webpage, wherein the redirect webpage includes a settlement offer to resolve an act of copyright infringement (an infringement event); and, instructions for providing the generated redirect webpage in response to the received redirected request for access to Internet content.

The computer readable medium may also include instructions for identifying an infringing computer, wherein the infringing computer includes a computer associated with the infringement event; instructions for identifying an ISP associated with the infringing computer; and, instructions for notifying the ISP that the infringing computer is associated with the infringement event.

The computer readable medium may also include instructions for associating a link with the redirect webpage, wherein the link is associated with a settlement webpage that a user can access to accept the settlement offer to resolve the infringement event.

The computer readable medium may also include instructions for determining if the client has settled all outstanding infringement events associated with the infringing computer.

The computer readable medium may also include instructions for providing an ISP with a settlement confirmation notice, wherein the settlement confirmation notice indicates that all outstanding infringement events have been resolved.

Another aspect of the present disclosure provides a system, comprising: a first receiving module configured to receive a notification from an external system, wherein the notification identifies a computer coupled to the system that is associated with an act of copyright infringement (an infringement event); a decision module configured to decide at least one of a plurality of actions to take in response to the received notification, wherein the plurality of actions include forwarding an infringer notice, redirecting a request for Internet access, or suspending Internet service; a second receiving module configured to receive a request for Internet access; and, a redirected module configured to redirect the request for Internet access to a redirect webpage, wherein the redirect webpage includes a link associated with a settlement webpage that includes a settlement offer to resolve the infringement event.

Additional features, advantages, and embodiments of the disclosure may be set forth or apparent from consideration of the detailed description, drawings and attachment. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for identifying multiple copyright infringements;

FIG. 2 shows an example of a process for detecting acts of copyright infringement and identifying repeat infringers; and

FIG. 3A shows an example of an infringement notification process, according to principles of the disclosure;

FIG. 3B shows an example of an infringer notification process, according to principles of the disclosure;

FIG. 3C shows an example of a further infringer notification process, according to principles of the disclosure; and

FIG. 4 shows an example of the redirect webpage, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

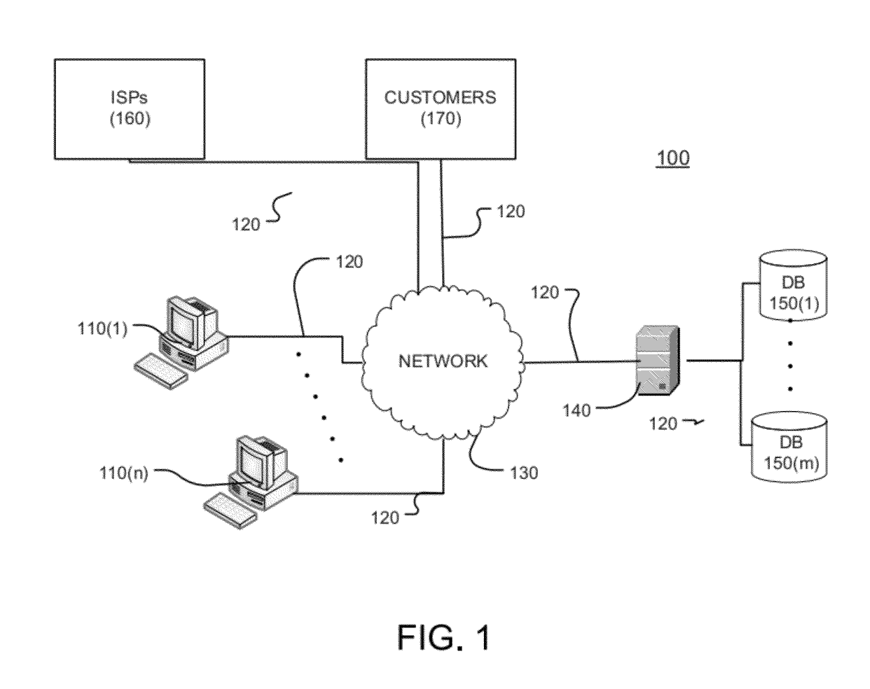

FIG. 1 shows an example of a system 100 for identifying multiple copyright infringements. The system 100 includes a plurality of Peer-to-Peer (P2P) computers 110(1) to 110(n) (where n is a positive, non-zero integer), a network 130, a server (or computer) 140, one or more databases 150(1) to 150(m) (where in is a positive, non-zero integer), one or more ISPs 160, and one or more customers 170. The server 140 and database(s) 150 may be connected to each other and/or the network 130 via one or more communication links 120. The P2P computers 110, the ISPs 160, and the customers 170 may be coupled to the network 130 via communication links 120. The customers 170 may include, for example, but are not limited to, individuals, privately owned entities, corporations, government agencies (e.g., the Department of Justice), or the like. The ISPs 160 may each be provided with a unique login identification and password to access a virtual space allocated to the particular ISP 160, which may include a portion of or an entire, database 150. Similarly, the customers 170 may each be provided with a unique login identification and password to access a virtual space allocated to the particular customer 170, which may include a portion of, or an entire database 150.

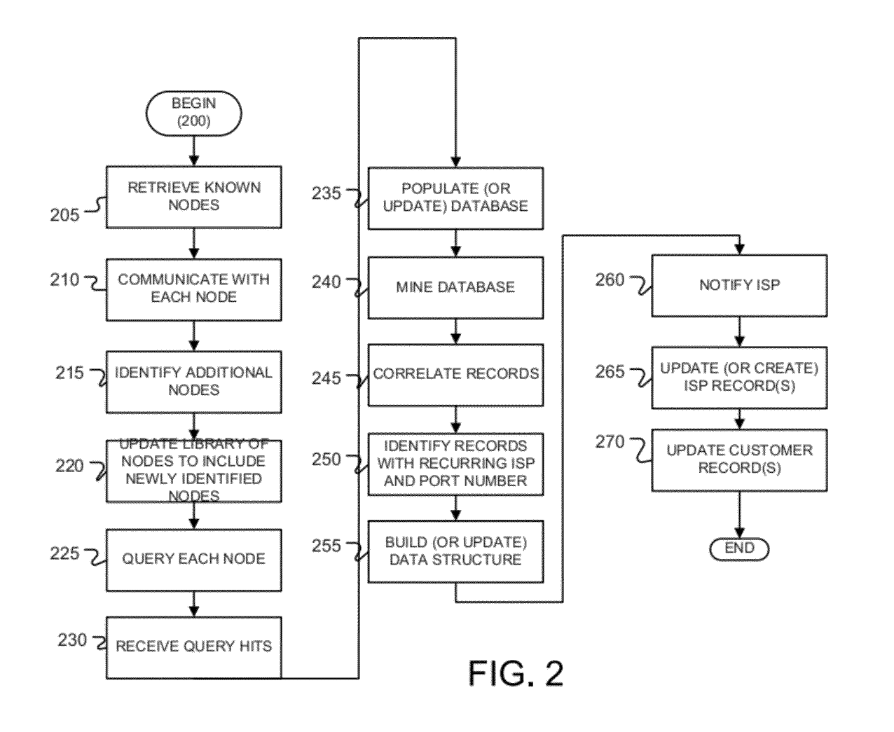

FIG. 2 shows an example of a process 200 for detecting acts of copyright infringement and identifying repeat infringers. The process 200 may be carried out, for example, by the server 140.

The process of FIG. 2 begins at step 205 by retrieving all known nodes in order to generate a library of nodes. A node may include, e.g., any device that is an endpoint of data transmission or reception across a network. The node may be, e.g., the computer associated with an act of infringement (i.e., the infringing computer). The node may be associated with, e.g., an IP address and/or a port. The library of known nodes may be retrieved from, e.g., local storage or remote storage. The library of known nodes may be retrieved. e.g., from a BitTorrent network. Then, at step 210, a signal may be sent to each of the nodes (or fewer than all of the nodes) in the library of nodes in an attempt to discover additional nodes. This signal may comprise, e.g., a query for additional nodes.

In response to the query, a response signal comprising, e.g., the results of the query, may be received from each of the nodes. In step 215, the process interprets the response signal and determines if the response signal includes an identification of one or more additional nodes. If an additional node is identified, the identifications of the one or more additional nodes may be added to the library of known nodes in step 220 and stored in, for example, local storage thereby providing the capability to update the library of known nodes.

After updating the library of nodes, step 225 provides that each of the nodes in the updated list of nodes may be queried to determine if the nodes include one or more predetermined files. Such a query may include, e.g., a request to receive a copy of the predetermined file. For purposes of this disclosure, it is contemplated that the predetermined file may include copyrighted material including, for example, a text file, an audio file, a video file, a multimedia file, or the like. The query of step 225 may include a keyword, a number, an alphanumeric character, or the like.

In step 230, one or more query hits may be received from the queried nodes. A query hit may include, e.g., a response to the query that indicates that the node will provide a copy of the copyrighted material. Such a response may thereby constitute an act of copyright infringement. Alternatively, or in addition, each query hit may include, e.g., infringement data. The infringement data may include, e.g., an IP address, a port number, a file name, a time stamp, a software version of the peer-to-peer software used to download for upload) the copyrighted material, an ISP identifier, or the like. Then, at step 235 a database 150 may be populated with data associated with the received query hit including, infringement data.

After the database has been populated with the infringement data, the database may be mined in step 240. In particular, each of the records in the database may be retrieved and analyzed or a query may be submitted to the database to return particular records containing infringement data. At step 245, all of the records for a portion of all records) may be correlated in order to cluster, or group together, all records having a predetermined relationship. The predetermined relationship may be, e.g., a same, or substantially the same, IP address and port number combination. As a result of the correlating process, it is possible to easily identify all records (or a portion of all records) that have the same, or substantially the same, predetermined relationship in step 250.

In order to facilitate efficient organization and maintenance of the clustered records, one or more data structures may be generated and populated with the identified records having the same, or substantially the same, IP address and port number combination at step 255. The data structure may be, e.g., a table, an array, a list, a linked list, a tree structure, or the like. If a corresponding data structure already exists, then the data structure may be updated with any newly identified records or information.

At step 260, an ISP may be notified when one or more acts of copyright infringement have been detected. Such an ISP may be notified, e.g., when a single act of copyright infringement has been detected. Alternatively, the method could be implemented in a manner that focuses on only notifying an ISP when a repeat infringer has been detected.

A repeat infringer may be detected by monitoring a predetermined threshold associated with the number of entries populating each generated data structure. For example, the method may provide that once a predetermined number (such as, for example, 5, 10, 20, or any positive number greater than 1) of data structure entries are identified that have substantially the same IP address and substantially the same port number, the ISP 160 associated with the IP address may be notified.

The notification may be in the form of a communication such as, for example, an email, a text message, a data transmission, a voice message, a mailed letter, or the like, and may include one or more of the IP address, the port number, and a time stamp. Alternatively, or in addition, the notification may include, e.g., updating a file, a data structure, a record, metadata, or the like, with at least a portion of the infringement data, including one or more of the IP address, the port number, the file name, and the time stamp, which may be accessed by the ISP.

In addition, or alternatively, the ISP may be provided with, e.g., a dashboard that is populated with ISP infringing data. The ISP infringing data may include, e.g., a total number of infringement events (or acts) for a given time period (e.g., a second, a minute, an hour, a day, a week, a month, a year, a time range, a date range, or the like), the total number of unique IP address—port number combinations during the time period, the number of infringement events associated with each unique IP address—port number combination, the infringement data for each infringement event, or the like.

The ISP infringing data may further include reconciliation data. The reconciliation data may include information regarding any payment that may have been received for a particular infringement event, whether the payment was forwarded to a copyright owner (or a proxy, or someone authorized by the copyright owner to receive payment, or the like), the identity of the copyright owner, or the like.

After the ISP 160 has been notified in step 260, the record(s) (or profile) that is associated with the particular ISP may be updated with the entries of the associated data structure in step 265. If a record does not exist for the particular ISP, then a record may be created.

A customer notification including customer data may be communicated to the customer 170. Such a customer data may be used e.g., to update customer records in step 270. The customer notification may be in the form of an electronic communication such as, for example, an email, a text message, a data transmission, a voice message, a mailed letter, or the like, and may include the customer data. The customer data may include infringement data for each ISP and/or unique address and port number combinations, including, for example: an identification of the ISP, the number of unique IP address and port number combinations, the number of infringing events associated with each unique IP address and port number combination, the file names downloaded or uploaded by each unique address and port number combination, the dates and times of each of the infringing events that are associated with each IP address and port number combination, or the like. The customer notification data may further include historical data for each ISP, for each unique IP address and port number combination, for each file name, or the like.

The customer may be provided with, e.g., a dashboard that is populated with customer data. The customer data may further include, for example, a total number of infringement events for a given time period (e.g., a second, a minute, an hour, a day, a week, a month, a year, a time range, a date range, or the like), the total number of unique IP address—port number combinations during the time period, the number of infringement events associated with each unique IP address and port number combination, the infringement data for each infringement event, or the like.

The customer data may further include customer reconciliation data. The reconciliation data may include payment information (e.g., payment that may have been received for a particular infringement event), the IP address and port number combination associated with the infringement event, whether the IP address and port number is a repeat offender, whether the ISP has taken any action (e.g., sent a notice to the infringer, redirected infringer's Internet access requests to a redirect webpage, disconnected the infringer, or the like), the nature of the type of action taken, or the like.

According to an aspect of the disclosure, a computer readable medium is provided containing a computer program, which when executed on, e.g., the server 140, causes the process 200 in FIG. 2 to be executed. The computer program may be tangibly embodied in the computer readable medium, comprising one or more program instructions, code segments, or code sections for performing steps 205 through 270 when executed by, e.g., the server 140, and/or the like.

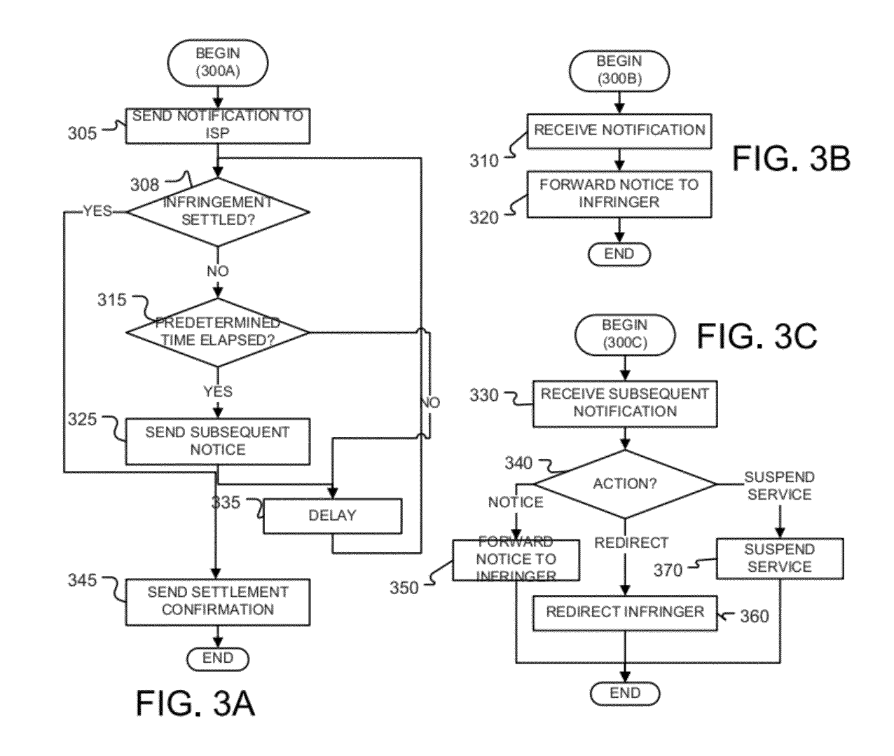

FIG. 3A shows an example of an infringement notification process 300A, according to principles of the disclosure. After an act of infringement has been identified and verified for a particular infringing computer by following, e.g., one or more steps of the process 200 (shown in FIG. 2), an infringement notification may be sent to the ISP that provides service to the infringing computer in step 305. The infringement notification may include, e.g., an email, a text message, a data transmission, a voice message, a written letter, or the like, which includes the ISP address, the port number, and/or a time stamp. Alternatively (or additionally), the infringement notification may include, e.g., updating a file, a table, a record, or the like, with at least a portion of the infringement data, including the IP address, the port number, the file name, and/or the time stamp, which may be accessed by the ISP.

After the infringement notification has been sent to the ISP, a determination may be made as to whether the infringement has been settled by the infringer in step 308. If the infringement is determined to have been settled (YES at step 308), then a settlement confirmation may be sent to the ISP in step 345, otherwise (NO at step 308) a determination may be made as to whether a predetermined time has elapsed (e.g., 1 day, 5 days, 10 days, etc.) in step 315.

If it is determined that the predetermined time has elapsed (YES at step 315), then a subsequent infringement notification may be sent to the ISP in step 325, otherwise (NO at step 315) no action is taken for a time period indicated in step 335. After the expiration of the time period established in step 335, the process may again determine whether the infringement has been settled in step 308. The time period (“delay”) may be substantially equal to, or less than, the predetermined time.

A computer readable medium may be provided containing a computer program, which when executed on, e.g., the server 140 (shown in FIG. 1), causes the process 300A in FIG. 3A to be carried out. The computer program may be tangibly embodied in the computer readable medium, comprising one or more program instructions, code segments, or code sections for performing steps 305 through 345 when executed by, e.g., one or more computers, server 140, and/or the like.

FIG. 3B shows an example of an infringer notification process 300B, according to principles of the disclosure. After an act of infringement has been identified and verified for a particular infringing computer by following, e.g., one or more steps of the process 200 (shown in FIG. 2), an ISP receives an infringement notification in step 310. After an ISP receives an infringement notification in step 310, the ISP may forward an infringer notice to the infringer identified in the infringement notification in step 320. The infringer notice may include, e.g., an email, a text message, a data transmission, a voice message, a mailed letter, or the like. The infringer notice may also include at least a portion of the infringement data including, e.g., an IP address, a port number, the file names downloaded or uploaded by the infringer, a software version of the peer-to-peer software used to download (or upload) the copyrighted material, historical information, an ISP identifier, and/or at least one time stamp associated with an infringing computer.

FIG. 3C shows an example of a further infringer notification process 300C, according to principles of the disclosure. After an act of infringement has been identified and verified for a particular infringing computer, e.g., by following one or more steps of the process 200 (shown in FIG. 2), an ISP may receive a subsequent infringement notification in step 330. The subsequent infringement notification may, e.g., suggest that an ISP take one of a plurality of actions. An ISP may then determine which action to take in response to the message at step 340. The actions may include, e.g., sending a subsequent infringement notice (NOTICE at step 340, then step 350), redirecting the infringer to a redirect webpage (REDIRECT at step 340, then step 360), or suspending service to the infringer (SUSPEND SERVICE at step 340, then step 370).

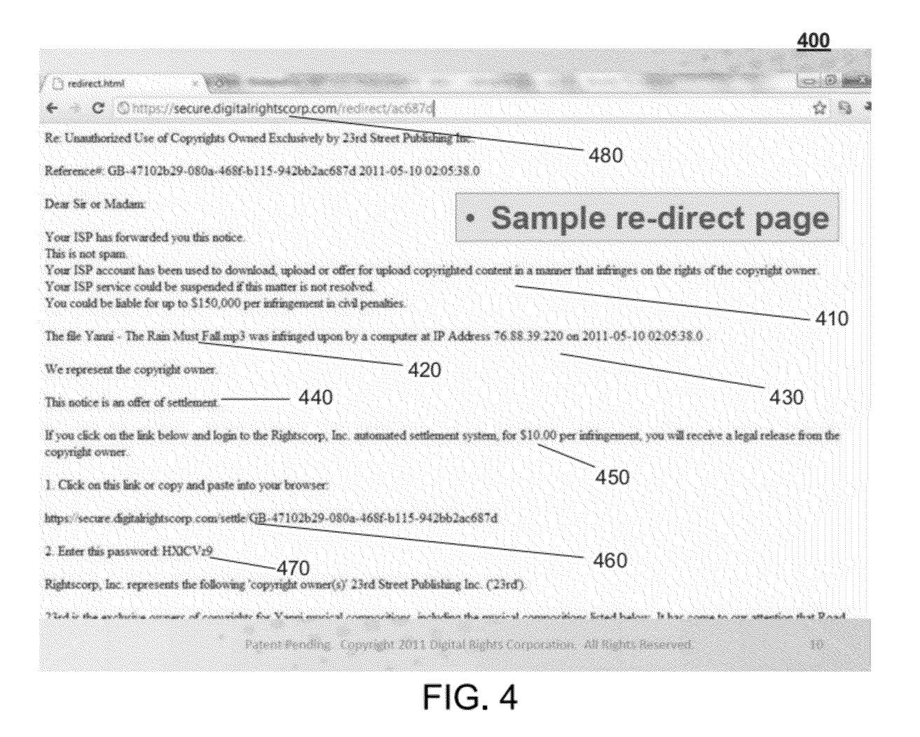

FIG. 4 shows an example of a redirect webpage 400 that may be provided to the user of an infringing computer if e.g., the ISP determines at step 340 that the user's request for Internet access should be redirected. The ISP may determine to redirect a request for Internet access for a plurality of different reasons. The ISP may determine to redirect a request for Internet access because, e.g., the ISP has received an infringement notification indicating that a computer (or node) associated with the ISP has been associated with an act of copyright infringement.

Alternatively, or in addition, the ISP may determine to redirect a request for Internet access because, e.g., the ISP has received a subsequent infringement notice suggesting that the ISP should redirect any requests for Internet access received by a user of a computer, or other node, associated with an act of copyright infringement.

Alternatively, the ISP may determine to redirect a request for Internet access because, e.g., the ISP has independently determined that the user of a computer is associated with an act of copyright infringement. However, one of ordinary skill in the art will appreciate that the disclosure is not limited to such examples. As a result, it will be readily apparent to one of ordinary skill in the art that an ISP may determine to redirect a request for Internet access for any reason that falls within the spirit and scope of the disclosure.

Redirect webpage 400 may include general information 410 associated with redirect webpage and the act of infringement. The redirect webpage may also include at least a portion of the infringement data. For example, the redirect webpage may include information identifying, the copyrighted work that was infringed 420. The redirect webpage may also include information identifying the infringing computer and/or the user associated with the infringing computer 430. Information that identifies the infringing computer and/or the user associated with the infringing computer may include, e.g., an IP address, a port number, a timestamp, a user ID, or the like. The redirect webpage may also include notice of a settlement offer to resolve the act of copyright infringement 440. The redirect webpage may also provide notice of a predetermined payment amount 450, that if satisfied, would settle and resolve the infringement. The predetermined payment amount may be, e.g., a flat fee.

The redirect webpage is not limited to only including the portions of the infringement data provided above. Instead, the redirect webpage 400 may be configured to include any portion of the infringement data within the redirect webpage 400. For example, the redirect webpage 400 may also include one or more of, e.g., a software version of the peer-to-peer software used to download (or upload) the copyrighted material, historical information associated with the computer associated with the act of infringement, and/or an ISP identifier.

The redirect webpage 400 may also include a link 460 associated with a payment website to resolve an outstanding infringement. The redirect webpage 400 may be configured to receive selection of the link. In response, the user may be provided access to a settlement resolution module. The settlement resolution module may be configured to accept payment from a user associated with an act of infringement for an amount equal to, e.g., the predetermined payment amount. Access to the settlement resolution module may require the use of a password 470. The password 470 may be provided by the redirect webpage 400.

The redirect webpage 400 may be generated and maintained by, e.g., the server 140 (shown in FIG. 1). After an ISP 160 (shown in FIG. 1) determines to redirect a user's request for Internet content at step 340, the ISP 160 may redirect the request for Internet content to the redirect webpage 400 that is associated with the particular infringing computer 110. The ISP 160 may continue to, e.g., indefinitely redirect the infringer computer 110 to the redirect webpage 400 on the server 140 until the infringer has settled the outstanding infringement(s) and the ISP 160 has received a settlement confirmation notice for the outstanding infringement(s) at step 345 (shown in FIG. 3C). Further, until the settlement confirmation notice is received from the server 140, the infringing computer 110 may be prevented from accessing any other site on the Internet, except for the redirect webpage 400.

Alternatively, or additionally, the infringing computer 110 may be redirected to one or more Department of Justice webpages related to civil and/or criminal penalties for acts of copyright infringement.

Alternatively, the Internet service being provided to an infringing computer may be suspended by the ISP at step 370. In the event that the ISP suspends Internet service being provided to an infringing computer, the service may remain suspended until the infringer has settled the outstanding infringement(s) and the ISP has received a settlement confirmation notice for the outstanding infringement(s) at step 345.

Further, the redirect webpage 400 may be generated and maintained by the ISP 160 or a customer 170 (shown in FIG. 1).

A computer readable medium may be provided containing a computer program, which when executed on, e.g., the ISP 160 and/or server 140, causes the processes 300B and/or 300C in FIGS. 3B and 3C, respectively, to be carried out. The computer program may be tangibly embodied in the computer readable medium, comprising one or more program instructions, code segments, or code sections for performing steps 310 through 320 and/or 330 through 370 when executed by, e.g., one or more computers, the ISP 160, server 140, and/or the like.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed:

1. A system for resolving an act of copyright infringement, comprising:
an infringement module configured to identify an infringing computer, wherein the infringing computer includes a computer associated with an infringement event;
an identification module configured to identify an ISP associated with the infringing computer;
a notification module configured to notify the ISP that the infringing computer is associated with the infringement event;
a receiving module configured to receive a redirected request for access to Internet content, wherein the request for Internet content has been redirected by the ISP; and
a generation module configured to generate a redirect webpage, wherein the redirect webpage includes a link associated with a settlement webpage that includes a settlement offer to resolve the infringement event.

2. The system of claim 1, wherein the redirect webpage includes information identifying the infringing computer.

3. The system of claim 2, wherein the information identifying the infringing computer includes an IP address, a port number, and a timestamp.

4. The system of claim 1, wherein the redirect webpage includes a notice of a settlement offer to resolve the infringement event.

5. The system of claim 1, wherein the redirect webpage includes information identifying the copyrighted work that was infringed in the infringement event.

6. The system of claim 1, the system further comprising:
a link selection module configured to receive a selection of the link; and,
a settlement resolution module configured to accept a predetermined payment from the user associated with the infringing computer in order to resolve the infringement event.

7. The system of claim 6, wherein the predetermined payment includes a flat fee established for each infringement event associated with the infringing computer.

8. The system of claim 7, the system further comprising:
a notification module configured to provide the ISP with a settlement confirmation notice, wherein the settlement confirmation notice indicates that all outstanding infringement events associated with the infringing computer have been resolved.

9. A method for resolving an act of copyright infringement, comprising:
receiving a redirected request for access to Internet content from a computer, which received a request for access to Internet content from an infringing computer, wherein the infringing computer includes a computer associated with an infringement event; and,
providing a redirect webpage to the infringing computer in response to the received redirected request for access to Internet content, wherein the redirect webpage includes a settlement offer to resolve an infringement event.

10. The method of claim 9, wherein said computer comprises an ISP.

11. The method of claim 9, the method further comprising;
identifying the infringing computer;
identifying an ISP associated with the infringing computer; and,
notifying the ISP that the infringing computer is associated with the infringement event.

12. The method of claim 9, the method further comprising:
generating a redirect webpage, based at least in part, on a determination that the infringing computer is associated with the infringement event.

13. The method of claim 12, wherein the step of generating the redirect webpage further comprises:
associating a link with the redirect webpage, wherein the link is associated with a settlement webpage that a user can access to accept the settlement offer to resolve the infringement event.

14. The method of claim 9, the method further comprising:
determining whether all outstanding infringements associated with the infringing computer have been resolved.

15. The method of claim 14, the method further comprising:
providing an ISP with a settlement confirmation notice, wherein the settlement confirmation notice indicates that all outstanding infringement events have been resolved.

16. A computer readable medium including instructions, which when executed by a computers, causes the computer to perform a method for resolving an act of copyright infringement, the instructions comprising:
instructions that instruct the computer to receive a redirected request for access to Internet content, wherein the request for Internet content has been redirected by an ISP;
instructions that instruct the computer to generate a redirect webpage, wherein the redirect webpage includes a settlement offer to resolve an infringement event; and,
instructions that instruct the computer to provide the generated redirect webpage in response to the received redirected request for access to Internet content.

17. The computer readable medium of claim 16, wherein the computer readable medium further comprises:
instructions for identifying an infringing computer, wherein the infringing computer includes a computer associated with the infringement event;
instructions for identifying an ISP associated with the infringing computer; and,
instructions for notifying the ISP that the infringing computer is associated with infringement the infringement event.

18. The computer readable medium of claim 16, wherein the instructions for generating the redirect webpage further comprises:
instructions for associating a link with the redirect webpage, wherein the link is associated with a settlement webpage that a user can access to accept the settlement offer to resolve the infringement event.

19. The computer readable medium of claim 16, wherein the computer readable medium further comprises:
instructions for determining if the client has settled all outstanding infringement events.

20. The computer readable medium of claim 16, wherein the computer readable medium further comprises:
instructions for providing an ISP with a settlement confirmation notice, wherein the settlement confirmation notice indicates that all outstanding infringement events have been resolved.

21. A system, comprising:
a first receiving module configured to receive a notification from an external system, wherein the notification identifies a computer coupled to the system that is associated with an act of infringement event;
a decision module configured to decide at least one of a plurality of actions to take in response to the received notification, wherein the plurality of actions include forwarding an infringer notice, redirecting a request for Internet access, or suspending Internet service;
a second receiving module configured to receive a request for Internet access; and,
a redirected module configured to redirect the request for Internet access to a redirect webpage, wherein the redirect webpage includes a link associated with a settlement webpage that includes a settlement offer to resolve an infringement.
